(19) United States
(12) Patent Application Publication
(10) Pub. No.: US 2011/0116095 A1
(43) Pub. Date: May 19, 2011

(54) Non-Spectroscopic Label-Independent Optical Reader System and Methods

(76) Inventors: Mark Francis Krol, Painted Post, NY (US); William James Miller, Horseheads, NY (US)

(21) Appl. No.: 12/947,054

(22) Filed: Nov. 16, 2010

Related U.S. Application Data
(60) Provisional application No. 61/261,543, filed on Nov. 16, 2009.

(51) Int. Cl. G01N 21/55; G01J 1/42

(52) U.S. Cl. 356/445; 356/218

(57) ABSTRACT

A non-spectroscopic, label-independent optical reader system is disclosed, where an exemplary system includes a broadband light source that generates broadband light made incident upon the resonant waveguide grating (RWG) biosensor. The light reflects from the RWG biosensor to form biosensor-reflected light. A photodetector receives the reflected light and generates a first detector signal representative of the reflected light intensity. An optical-edge filter can filter the broadband light, the reflected light, or both. A processor calculates a resonant wavelength for the RWG biosensor based on the detector signal.

### CROSS-REFERENCE TO RELATED APPLICATIONS

This application claims the benefit of priority under 35 U.S.C. §119(e) of U.S. Provisional Application Ser. No. 61/261,543 filed on Nov. 16, 2009. The content of this application and the entire disclosure of any publication or patent document mentioned herein is incorporated by reference.

### FIELD

The present disclosure relates to label-independent optical readers, and in particular to optical reader systems and methods that do not use a spectrometer.

### BACKGROUND

Label-independent detection (LID) optical readers can be used to detect drug molecule binding to a target molecule such as a protein and to detect the interaction of drug molecules with cells. Certain types of LID optical readers measure changes in refractive index on the surface of an individual resonant waveguide grating (RWG) biosensor, for arrays of RWG biosensors, and for RWG biosensors integrated in the individual wells of a microplate.

In the general operation of a LID optical reader, spectrally broadband light from a broadband optical light source is directed to each RWG biosensor. Only light whose wavelength is resonant with the RWG biosensor is strongly reflected. The reflected light is collected and spectrally analyzed to determine the RWG biosensor resonance wavelength. A measured shift in the resonance wavelength is representative of a refractive index change and thus biochemical/cell/drug interaction occurring at the surface of the RWG biosensor.

Most optical readers use one or more spectrometers to analyze light reflected from the biosensor. This makes such optical reader systems relatively expensive and complex. Further, the resonant wavelength is determined indirectly by processing the spectra obtained from the one or more spectrometers. This typically includes having to use an algorithm, such as a centroid-finding algorithm.

### SUMMARY

An aspect of the disclosure is a non-spectroscopic optical reader system for reading a RWG biosensor. The system includes a broadband light source that generates broadband light that is incident the RWG biosensor and that reflects therefrom to form biosensor-reflected light having an intensity. A first photodetector receives the biosensor-reflected light and generates a first detector signal representative of the first intensity. An optical edge filter filters either the broadband light or the bio sensor-reflected light. A processor receives the first detector signal and calculates therefrom a resonant wavelength for the RWG biosensor.

Another aspect of the disclosure is a non-spectroscopic optical system for label-independent reading of a RWG biosensor. The system includes a broadband light source that generates broadband light that is incident upon the RWG biosensor and that reflects therefrom. The system also includes an optical edge filter that transmits and reflects respective portions of the reflected light from the RWG biosensor. The system also has first and second photodetectors disposed relative to the optical edge filter to respectively receive the transmitted and reflected light portions and to generate therefrom respective first and second detector signals. The system further includes a processor connected to the first and second photodetectors. The processor receives the first and second detector signals and generates therefrom a signal representative of a resonant wavelength of the RWG biosensor.

Another aspect of the disclosure is a non-spectroscopic method of label-independent reading of a RWG biosensor operably supported by a support structure. The method includes directing broadband light to be incident upon the RWG biosensor and generating reflected light therefrom. The method also includes transmitting the incident broadband light or the reflected light through an optical edge filter. The method further includes detecting the transmitted and filtered portion of the reflected light with a first photodetector and generating a first detector signal representative of a first intensity of the first detected light. The method additionally includes determining a resonant wavelength based on the first detector signal.

These and other advantages of the disclosure will be further understood and appreciated by those skilled in the art by reference to the following written specification, claims and appended drawings.

### BRIEF DESCRIPTION OF THE DRAWINGS

A more complete understanding of the present disclosure may be had by reference to the following detailed description when taken in conjunction with the accompanying drawings, wherein:

FIG. 1 is a generalized schematic diagram of an example non-spectroscopic optical reader system used to interrogate one or more RWG biosensors;

FIG. 2 is a plot of an example optical edge filter transmission T vs. wavelength (nm);

FIG. 3 is a plot of the intensity (relative units) versus wavelength (nm) for light reflected from the RWG biosensor, illustrating the resonant wavelength and the shift therein (as indicated by arrow 139) when biological material is present on the surface of the RWG biosensor;

FIG. 4 is a plan view of a RWG biosensor support structure in the form of a microplate that comprises a support plate with a surface having a plurality of wells formed therein that each contain a RWG biosensor;

FIG. 5A is a schematic diagram of an example embodiment of the non-spectroscopic optical reader system that utilizes a single photodetector disposed in the optical path adjacent and downstream of an optical edge filter;

FIG. 5B is similar to FIG. 5A and illustrates an example embodiment of the non-spectroscopic optical reader system wherein the optical edge filter is disposed in the optical path between the light source unit and the RWG biosensor, and that includes a monitoring photodetector for normalizing the system signal;

FIG. 5C is similar to FIG. 5A, and illustrates an example embodiment of the non-spectroscopic optical reader system that utilizes two photodetectors respectively arranged to receive transmitted and reflected light from the optical edge filter and generate respective detector signals;

FIG. 5D is similar to FIG. 5C and illustrates an example embodiment of the non-spectroscopic optical reader system that utilizes two photodetectors and where a beamsplitter enables a portion of the optical path to lie along the system axis, and wherein a polarizer and quarter-wave wave plate serve to optically isolate the two photodetectors;

FIG. 6A is a schematic diagram of an example embodiment of the optical-fiber-based non-spectroscopic optical reader system that utilizes a single photodetector;

FIG. 6B is similar to FIG. 6A and illustrates an embodiment of a single-photodetector optical-fiber-based non-spectroscopic optical reader system wherein the optical edge filter is arranged adjacent the light source unit;

FIG. 6C is similar to FIG. 6A and illustrates an embodiment of a two-photodetector optical-fiber-based non-spectroscopic optical reader system;

FIG. 7 is a plot of the splitting ratio (SR) of the WDM edge filter for the two output ports (solid line) and (dashed line) for the optical-fiber-based non-spectroscopic optical reader system of FIG. 6C;

FIG. 8 is a schematic diagram similar to FIG. 5C and illustrates an example imaging-based non-spectroscopic optical reader system; and

FIG. 9 is a schematic diagram of an example signal-processing system for calculating a system signal representative of a resonance wavelength based on input signals from the two photodetectors of a two-photodetector non-spectroscopic optical reader system.

### DETAILED DESCRIPTION

Reference is now to embodiments of the disclosure, exemplary embodiments of which are illustrated in the accompanying drawings.

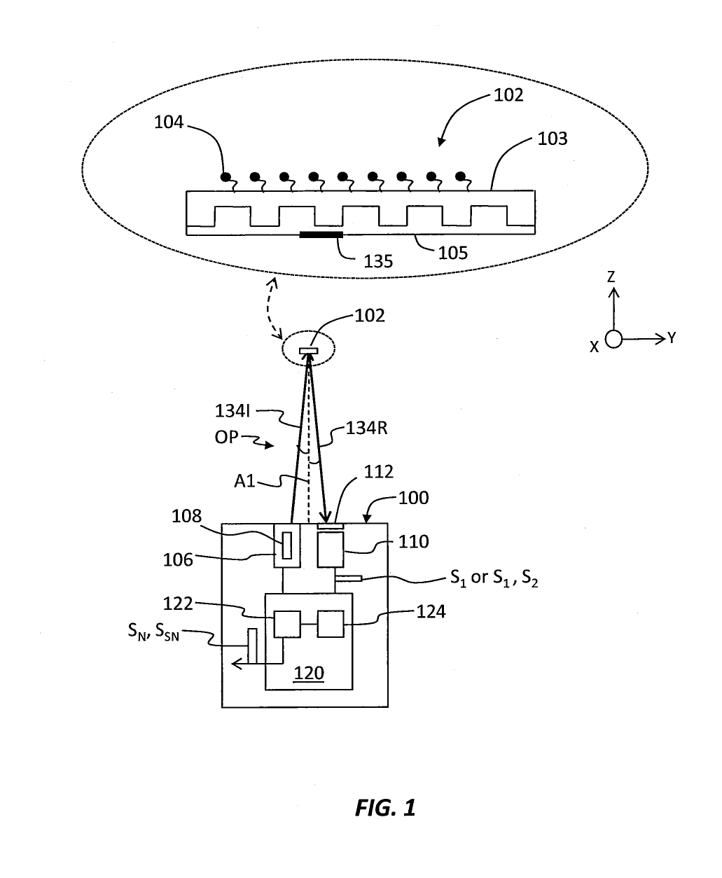

FIG. 1 is a generalized schematic diagram of an example non-spectroscopic optical reader system (“system”) 100 used to interrogate one or more RWG biosensors 102 each having a sensor surface 103 and a substrate bottom surface 105, to determine if a biological interaction has occurred with biological substance 104 present on the RWG biosensor. System 100 includes a light source unit 106, a photodetector unit 110, an optical edge filter 112, and a controller/signal processor 120. A system axis A1 normally intersects RWG biosensor 102.

An example light source unit 106 includes a broadband light source 108, such as super luminous diode (SLD). An example wavelength band Δλ, for broadband light source 108 ranges from about 820 nm to about 840 nm.

Controller/signal processor 120 includes a processor unit (“processor”) 122 operably coupled to a memory unit (“memory”) 124. In an example embodiment, processor 122 is adapted (e.g., is programmed or is programmable) to process information provided to controller/signal processor 120 from photodetector unit 110 or from memory 124. In an example embodiment, controller/signal processor 120 is or includes a programmable computer. The term “processor” includes a general purpose processor, a microcontroller (i.e., an execution unit with memory, etc., integrated within a single integrated circuit), or a digital signal processor. Memory 124 may include any of the common forms of digital memory used in electronic systems and computers. Memory 124 is used, for example, to store data, including resonant wavelength information obtained as described below, and computer-readable instructions (e.g., software) for carrying out signal-processing methods in processor 122.

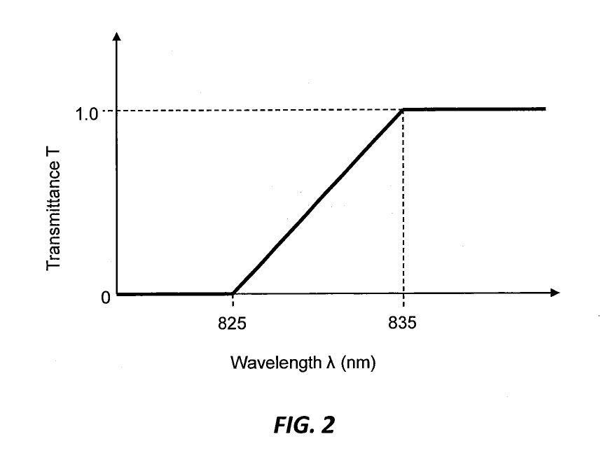

FIG. 2 is a plot of transmittance T vs. wavelength (nm) showing the characteristic linear transmittance of an example optical edge filter 112. An example wavelength range of optical edge filter is between about 825 nm (T=0) and 835 nm (T=1). An example slope of the T vs. wavelength curve is 1/10 nm⁻¹.

With reference again to FIG. 1, in the general operation of system 100, light source 106 generates an incident light 134I. This light is incident upon RWG biosensor 102 at substrate bottom surface 105 and forms a light spot 135 thereon. Incident light 134I penetrates surface 105 and interacts with the biological substance 104 on sensor surface 103 and reflects therefrom, forming a reflected light 134R. Example RWG biosensors 102 make use of changes in the refractive index at sensor surface 103 that affect the waveguide coupling properties of incident light 134I and reflected light 134R from the RWG biosensor to enable label-free detection of biological substance 104 (e.g., cell, molecule, protein, drug, chemical compound, nucleic acid, peptide, carbohydrate, etc.) on the RWG biosensor. Biological substance 104 may be located within a bulk fluid deposited on sensor surface 103, and the presence of this biological substance alters the index of refraction at the RWG biosensor surface. In embodiments, sensor surface 103 can be coated with, for example, biochemical compounds (not shown) that only allow surface attachment of specific complementary biological substances 104, thereby enabling RWG biosensor 102 to be both highly sensitive and highly specific.

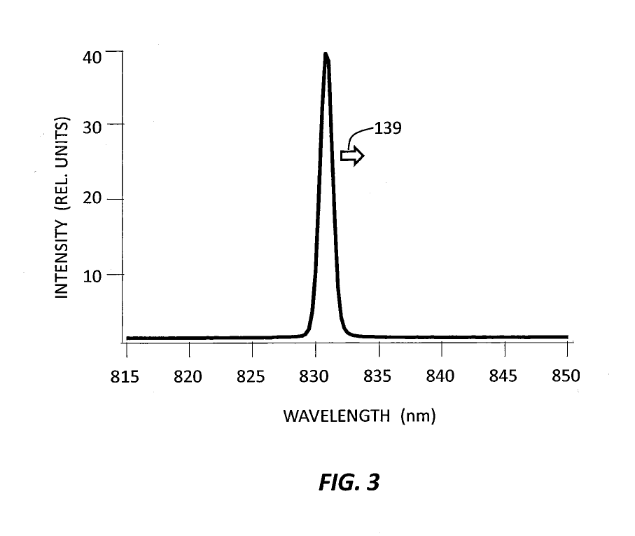

FIG. 3 is a plot of the intensity (relative units) versus wavelength for reflected light 134R. When chemical binding occurs at RWG biosensor surface 103, the resonant wavelength λ_{R} shifts slightly, as indicated by arrow 139. In this way, system 100 and RWG biosensor 102 can be used to detect a wide variety of biological substances 104 and changes thereof. Likewise, RWG biosensor 102 can be used to detect the movements or changes in cells immobilized to sensor surface 103. For example, when the cells move relative to RWG biosensor 102, or when they incorporate or eject material, a refractive index change occurs.

With reference again to FIG. 1, reflected light 134R passes through optical edge filter 112 and can be detected by photodetector unit 110. Incident and reflected light 134I and 134R define an optical path OP. Optical edge filter 112 can be located anywhere in the optical path OP between light source 106 and photodetector unit 110. In some example embodiments of system 100, optical path OP is symmetric about system axis A1, while in other embodiments the optical path lies along at least a portion of the system axis.

Controller/signal processor 120 receives from photodetector unit 110 a detector photocurrent signal S₁ or detector photocurrent signals S₁ and S₂ (depending on the number of photodetectors 114 in the photodetector unit), and processor 122 processes these signals according to the methods described below. Controller/signal processor 120 is configured to determine if there are any changes (e.g., 1 part per million) in the RWG biosensor resonance wavelength λ_{R} caused by the presence of biological substance and changes thereof. The output of this signal processing is a power-normalized system signal S_{N} for each RWG biosensor 102 representative of a value for the resonant wavelength λ_{R}. In an example where normalized system signal is self-normalized (as described below), the system signal is denoted S_{SN}.

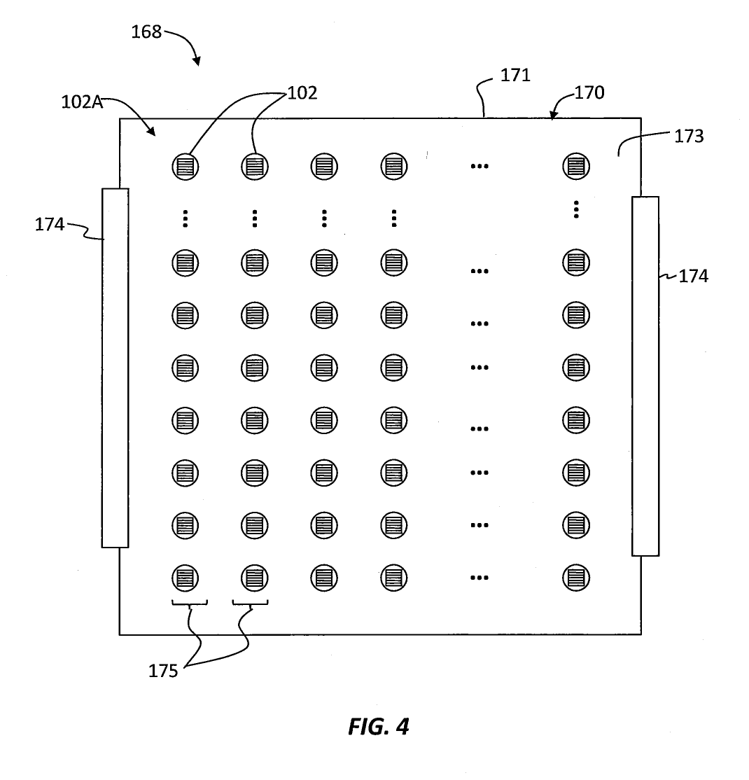

In embodiments, one or more RWG biosensors 102 can be supported by a support structure 168 that facilitates reading of one or more RWG biosensors by system 100. FIG. 4 is a plan view of an example support structure 168 in the form of a microplate 170 that comprises a support plate 171 with a surface 173 having a plurality of wells 175 formed therein. An example support plate 171 has a two-part construction of an upper plate and a lower plate (not shown), as described for example in U.S. Patent Application Publication No. 2007/0211245.

Microplate 170 of FIG. 4 illustrates an exemplary configuration where RWG biosensors 102 are arranged in an array 102A and operably supported in respective wells 175. An exemplary RWG biosensor array 102A has a 4.5 mm pitch for RWG biosensors 102 that are 2 mm square, and includes 16 RWG biosensors per column and 24 RWG biosensors in each row. A microplate holder 174 is also shown holding microplate 170. Many different types of plate holders can be used as microplate holder 174.

It is noted here that system 100 of the present disclosure is not limited to the use of microplates, and generally can be used with any support structure 168 capable of holding one or more RWG biosensors 102. Other suitable support structures include, for instance, microscope slides, microfluidic structures, micro-arrays, petri dishes, custom single and multiple biosensor support structures, and the like

In the case where multiple RWG biosensors 102 are operably supported (e.g., as an array 102A), then they can be used to enable high-throughput drug or chemical screening studies. For a more detailed discussion about the detection of a biological substance 104 (or a biomolecular binding event) using scanning optical reader systems, reference is made to U.S. patent application Ser. No. 11/027,547. Other optical reader systems are disclosed in, for example, U.S. Pat. No. 7,424,187 and U.S. Patent Application Publications No. 2006/0205058 and 2007/0202543.

### Example System Embodiments

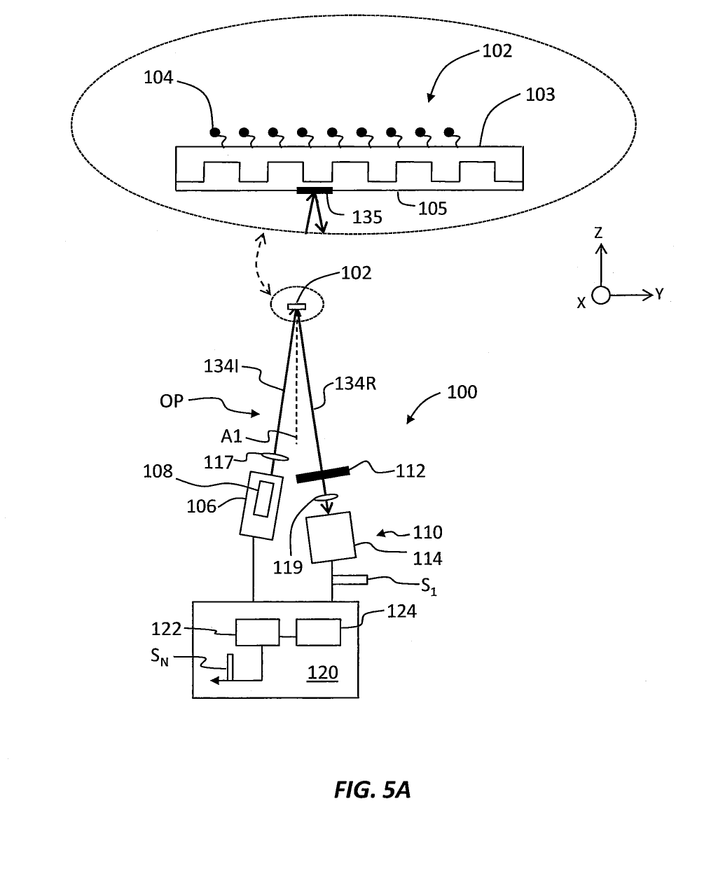

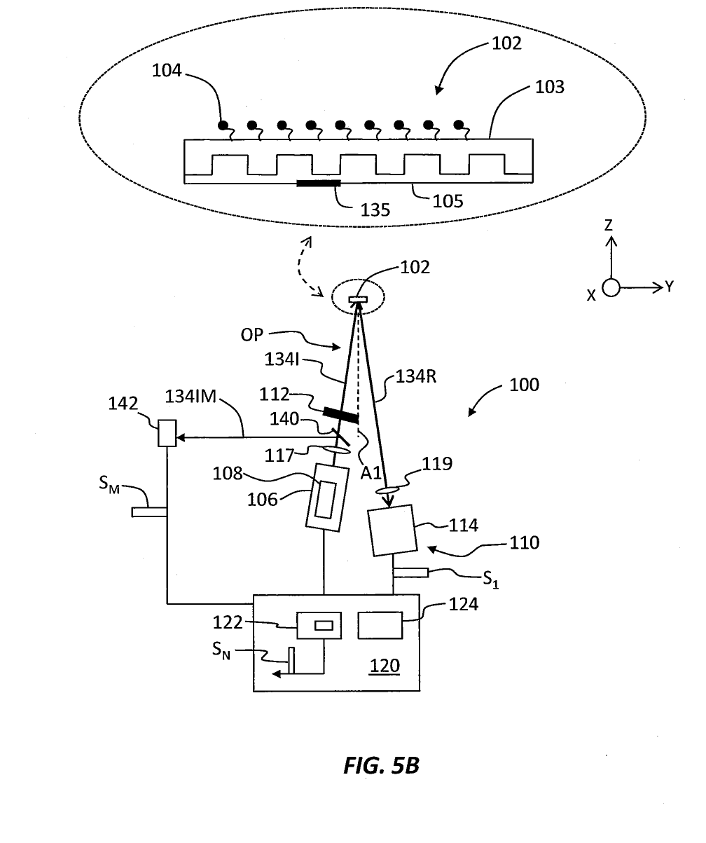

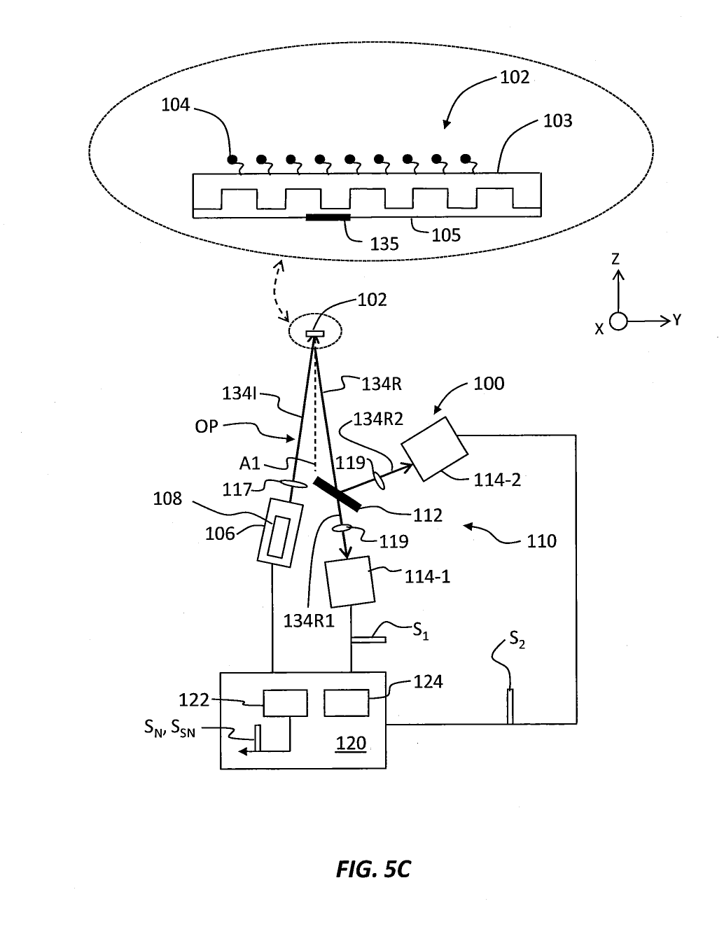

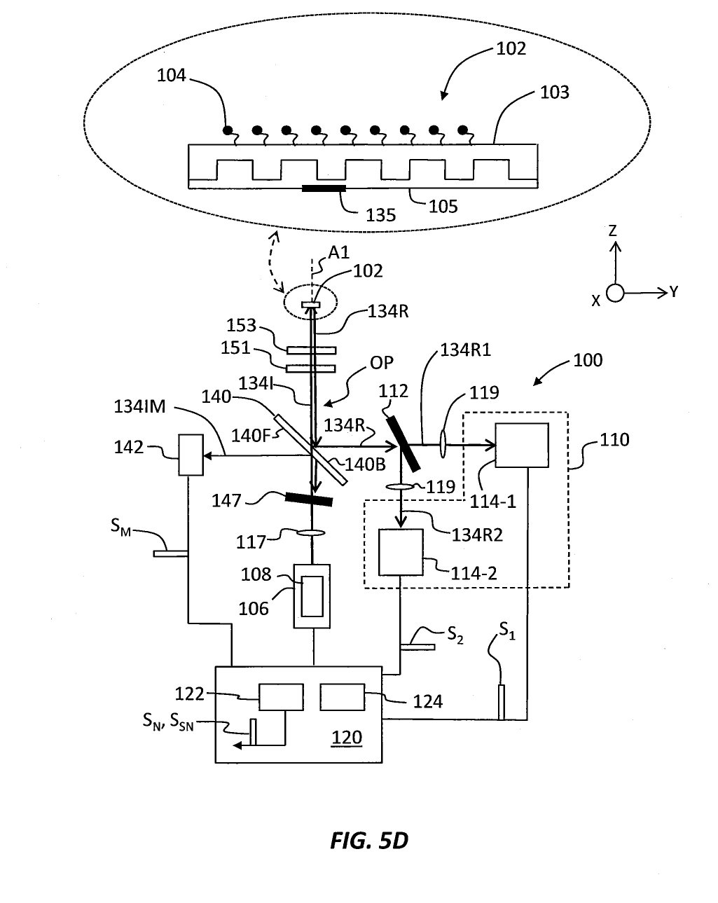

FIG. 5A is similar to FIG. 1 and illustrates an example embodiment of system 100 wherein photodetector unit 110 includes a photodetector 114 disposed to receive reflected light 134R transmitted through optical edge filter 112. Optical edge filter 112 is shown disposed in optical path OP between RWG biosensor 102 and detector unit 110. An optional collecting lens 119 is provided in optical path OP between optical edge filter 112 and photodetector 114 to assist in collecting reflected light 134R and directing it to the photodetector. Photodetector 114 generates detector signals S₁ that are received and processed by controller/signal processor 120 as described below.

FIG. 5B illustrates a single-detector embodiment of system 100 similar to that shown in FIG. 5A, but with the optical edge filter 112 disposed between the broadband light source and RWG biosensor. System 100 of FIG. 5B includes a power monitoring system in the form of a beamsplitter 140 of known reflectivity/transmittance arranged in the optical path OP in incident light 134I, and a monitoring photodetector 142 arranged to receive a known portion 134IM of incident light 134I redirected to the photodetector. Monitoring photodetector 142 sends a monitoring signal S_{M} to controller/signal processor 120 to provide a measure of the power in “monitoring” incident light 134IM and thus a measure of the power in incident light 134I.

FIG. 5C illustrates an alternate embodiment of system 100 similar to that shown in FIG. 5A, but where the photodetector unit 110 includes two photodetectors 114-1 and 114-2 disposed relative to optical edge filter 112 to respectively receive transmitted and reflected light 134R1 and 134R2 therefrom. Photodetectors 114-1 and 114-2 generate respective detector signals S₁ and S₂, which are received and processed by the controller/signal processor 120 as described below.

FIG. 5D illustrates an example embodiment of system 100 similar to FIG. 5C wherein a portion of the optical path OP, as defined by incident and reflected light 134I and 134R, lies along system axis A1. System 100 of FIG. 5D includes, disposed along the system axis in order from light source unit 106 and RWG biosensor 102: optional lens 117, a band-pass filter 147, a beamsplitter 140, a polarizer 151 and a quarter-wave waveplate 153.

Band-pass filter 147 is used to narrow the bandwidth of broadband light source 108, and can also be located in light source unit 106. Beamsplitter 140 has front and back surfaces 140F and 140B. As incident light 134I enters beamsplitter 140 at front surface 140F and exits at back surface 140B, a small portion of the incident light is reflected to form the aforementioned monitoring light 134IM, as discussed in connection with FIG. 5B. Example beamsplitters 140 include a beamsplitter cube, a beamsplitter plate and a pellicle beamsplitter. A 20× reduction in the amount of power measured in monitoring light 134IM was observed when using a pellicle beamsplitter versus using a cube beamsplitter.

In an example embodiment, monitoring photodetector 142 is arranged to receive and detect monitoring light 134IM and transmit a corresponding monitoring signal S_{M} to controller/signal processor 120. As in the example shown in FIG. 5B, monitoring signal S_{M} can be used to monitor the performance of light source unit 106 (e.g., power levels, fluctuations, etc.), and this information can be used to improve the overall performance of system 100.

Polarizer 151 and quarter-wave waveplate 153 are configured to optically isolate photodetectors 114-1 and 114-2 and to mitigate a non-resonant sensor response. A portion of reflected light 135R traveling along system axis A1 is reflected by beamsplitter 140 and travels to edge filter 112, which directs first and second reflected light 134R1 and 134R2 to respective photodetectors 114-1 and 114-2. Photodetectors 114-1 and 114-2 generate respective detector signals S₁ and S₂, which are received and processed by the controller/signal processor 120 as described below.

With reference to FIG. 5C and FIG. 5D, in the general operation of the two-detector embodiments of system 100, light source unit 106 (and optional lens 117) generates broadband incident light 134I that reflects from RWG biosensor 102, to form reflected light 134R. Reflected light 134R is incident upon optical edge filter 112, which forms from this reflected light a “transmitted” reflected light 134R1 and a “reflected” reflected light 134R2. Optional lens 119 can be used to help collect and direct reflected light 134R. Light 134R1 is detected by photodetector 114-1, while light 134R2 is detected by photodetector 114-2.

Photodetectors 114-1 and 114-2 generate respective detectors signals S₁ and S₂ having respective photocurrents I₁ and I₂ that are representative of the intensity of light detected. Detector signals S₁ and S₂ travel to controller 120. Processor 122 receives detector signals S₁ and S₂ and processes these signals according to the methods described below to generate system signal S_{SN} representative of a value for resonant wavelength λ_{R}. In embodiments, information from detector signals S₁ and S₂ is stored in memory 124 and then provided to processor 122.

The operation of single-detector embodiments of system 100 of FIGS. 5A and 5B is similar to that of the two-detector embodiments of FIG. 5C and FIG. 5D, except that there is only one detector signal S_{I} generated and processed to calculate the system signal S_{N}. An advantage of using a two-detector system 100 is that such a system generates two detector signals S₁ and S₂ that provide for a more accurate determination of system signal S, as described below.

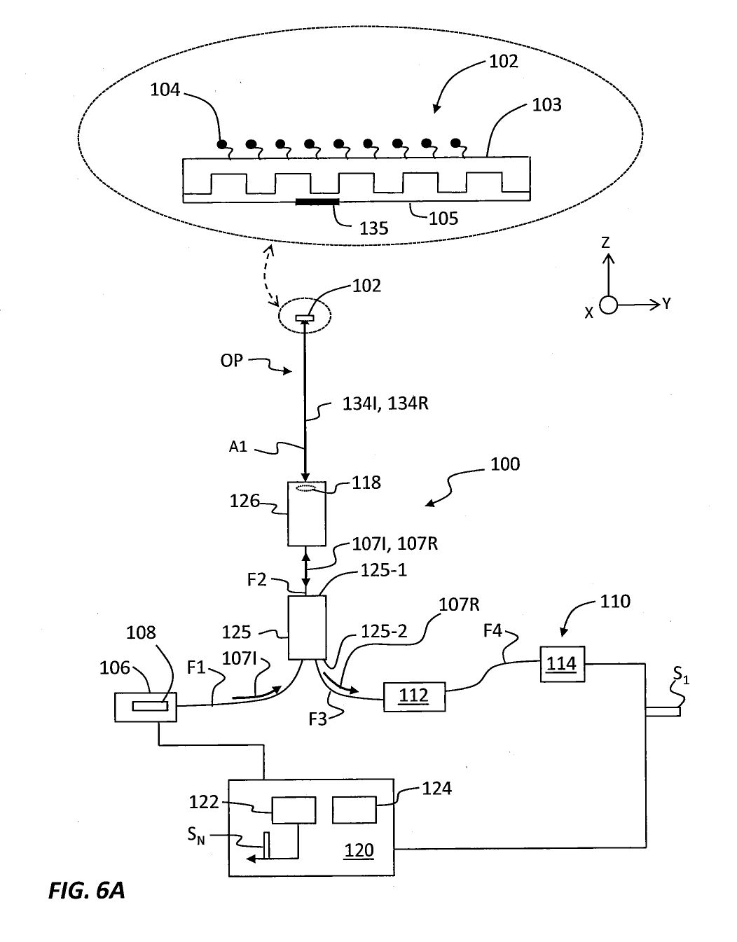

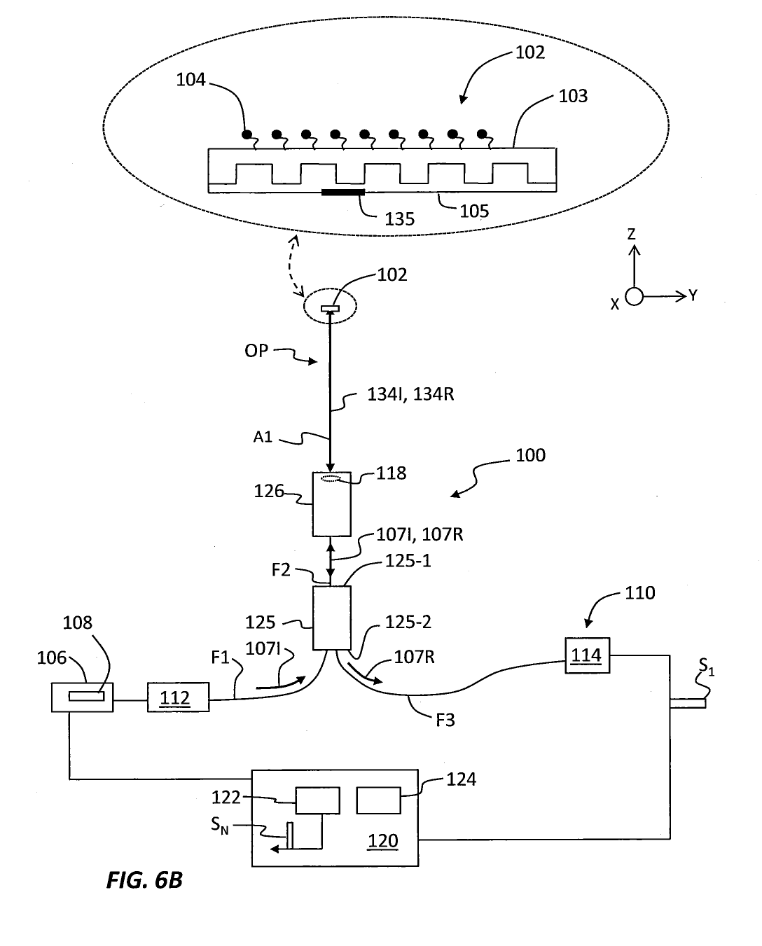

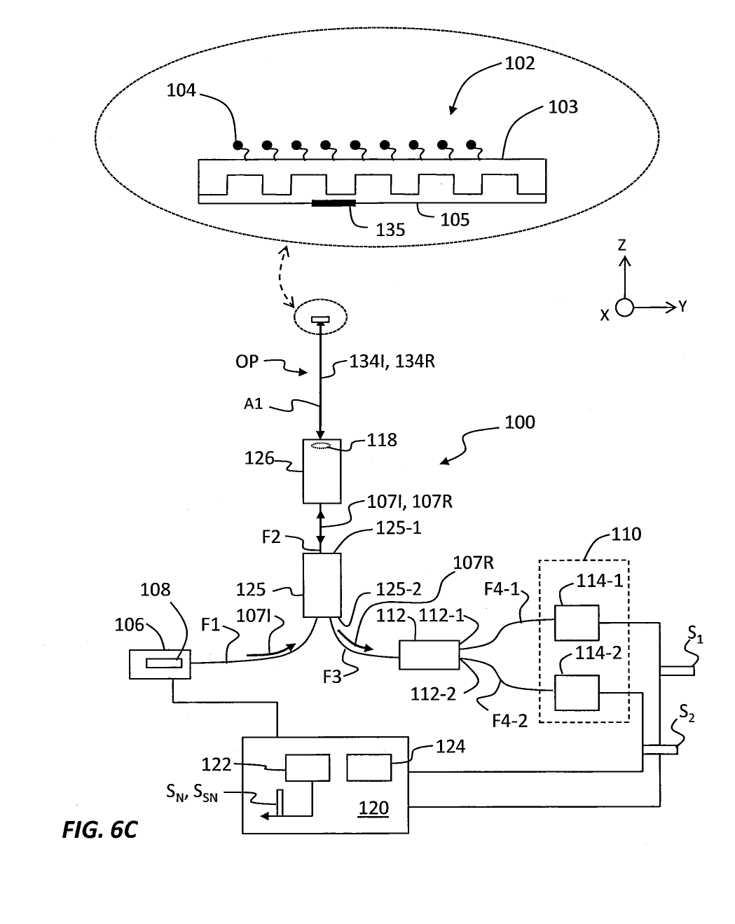

FIGS. 5A through 5D describe example “free space” systems wherein the light travels through free space rather than waveguides. FIGS. 6A through 6C are schematic diagrams of fiber-based “guided wave” systems 100 where the light travels mostly through optical waveguides, which are shown by way of example as being in the form of optical fibers.

FIG. 6A is a schematic diagram of an example guided-wave system 100 that uses a single photodetector 114 in photodetector unit 110. Fiber-based system 100 includes a first optical fiber section F1 that connects light source unit 106 to a 1×2 coupler 125 having a “1×” end 125-1 and a “2×” end 125-2. A second optical fiber section F2 connects the “1×” coupler end 125-1 to an optical fiber collimator 126.

Optical fiber collimator 126 includes a lens 118 to facilitate forming incident light 134I. A third optical fiber section F3 connects the “2×” coupler end 125-2 to optical edge filter 112, which in embodiments can be the same, but appropriately packaged, optical edge filter used in the free-space embodiments of system 100 described in FIGS. 5A through 5D. Optical edge filter 112 as shown in FIG. 6A is in the form of a coarse wavelength division multiplexer (hereinafter, “WDM edge filter 112”). An optical fiber section F4 connects the WDM edge filter 112 to photodetector unit 110 having the single photodetector 114. Photodetector 114 can be electrically connected to the controller/signal processor 120.

FIG. 6B illustrates an embodiment of the single-photodetector guided-wave system 100 similar to that shown in FIG. 6A, but where the edge filter 112 is located between the light source 106 and the RWG biosensor 102.

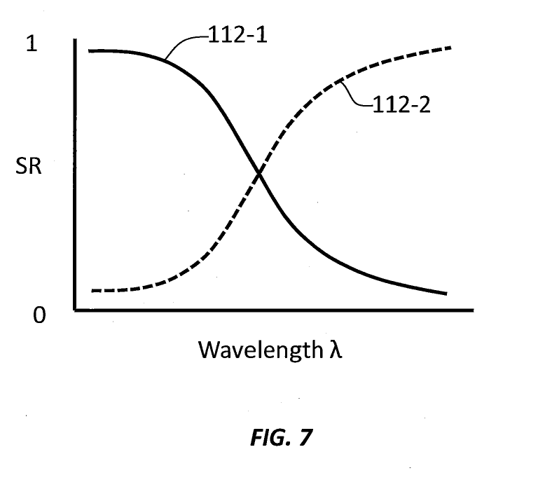

FIG. 6C illustrates an embodiment of a guided-wave system 100 similar to that shown in FIG. 6A, but that illustrates a two-photodetector embodiment with two optical fiber sections F4-1 and F4-2, respectively, connecting the two output ports 112-1 and 112-2 of WDM edge filter 112 to photodetectors 114-1 and 114-2 in photodetector unit 110. FIG. 7 is a plot of the splitting ratio (SR) of WDM edge filter 112 for the two output ports 112-1 (solid line) and 112-2 (dashed line). A variety of fiber-optic and micro-optic based components can be selected to implement the fiber-based system. These can include, for example, optical circulators, dual fiber collimators, etc.

With reference again to FIG. 6C, the two-photodetector fiber-optic embodiment of system 100 works in essentially the same manner as the two-detector free-space embodiment of the system as shown in FIGS. 5C and 5D. Light source unit 106 generates light 107I that travels over first optical fiber section F1 to the “2×” coupler end 125-2. The 1×2 coupler 125 couples light 1071 into second optical fiber section F2 and travels to optical fiber collimator 126, which is configured (e.g., with lens 118) to form incident light 134I along system axis A1. This light is incident upon RWG biosensor 102 and is reflected therefrom along system axis A1 to form reflected light 134R. Thus, the optical path OP of system 100 lies along system axis A1.

Optical fiber collimator 126 receives reflected light 134R and converts it to guided light 107R that travels over optical fiber section F2 to the “1 ×” coupler end 125-1. The 1×2 coupler 125 outputs guided light 107R at the “2×” coupler end 125-2 to optical fiber section F3. Guided light 107R travels over optical fiber section F3 to WDM edge filter 112, which transmits a portion 107R1 of guided light 107R to photodetector 114-1 and another portion 107R2 to photodetector 114-2 according to the splitting ratio plot of FIG. 7. The guided light portions 107R1 and 107R2 created by WDM edge filter 112 are equivalent light 134R1 and light 134R2 of the free-space embodiments of system 100 of FIGS. 5C and 5D.

As with the free-space embodiment of system 100 of FIG. 5C, in the optical fiber embodiment of system 100 of FIG. 6C, photodetectors 114-1 and 114-2 generate respective detectors signals S₁ and S₂ having respective photocurrents I₁ and I₂ that are representative of the intensity of light detected. Detector signals S₁ and S₂ travel to controller 120. Processor 122 receives detector signals S₁ and S₂ and processes these signals according to the methods described below to generate system signal S_{SN} representative of a value for resonant wavelength λ_{R}.

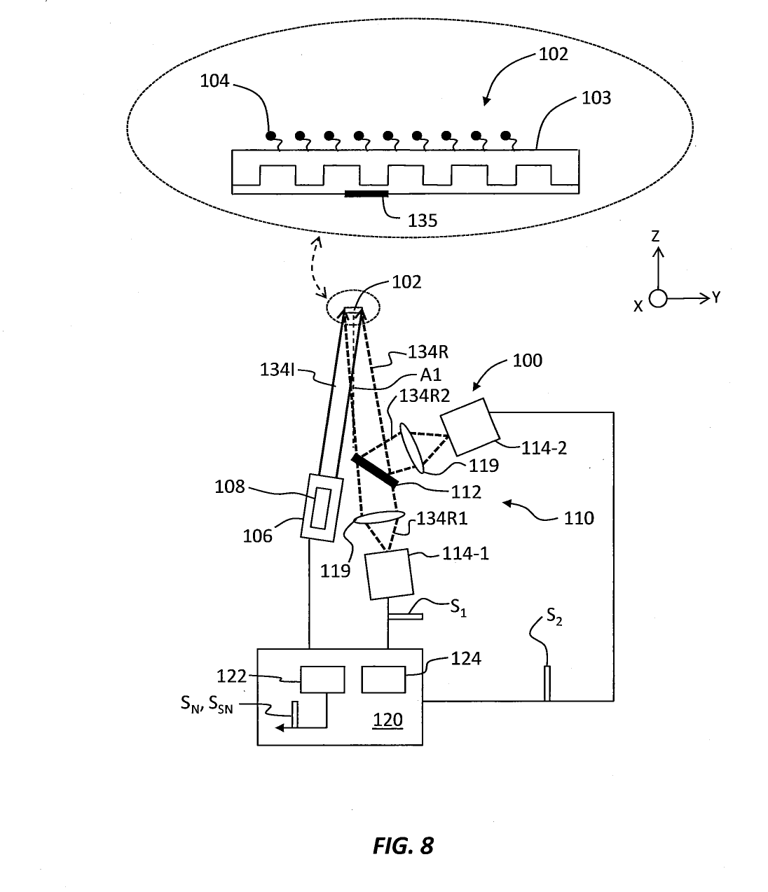

FIG. 8 is a schematic diagram of an example imaging-based system 100. System 100 of FIG. 8 includes photodetectors 114-1 and 114-2 in the form of image sensors such as charge-coupled device (CCD) cameras. An image of a single RWG biosensor 102 or of multiple RWG biosensors can be formed on image sensors 114-1 and 114-2 via reflected light 134R (dashed lines). The pixels (not shown) of the image sensors 114-1 and 114-2 capture respective images of the one or more RWG biosensors 102 and provide respective detector signals S₁ and S₂ representative of the captured images. Controller/signal processor 120 then processes the detector signals S₁ and S₂ and generates system signal S_{N} or S_{SN} (depending on if one or two image sensors are used) representative of one or more resonant wavelengths λ_{R} associated with the one or more imaged RWG biosensors 102. As in the embodiments shown in FIGS. 5A through 5D, one or two image sensors can be selected.

### Mathematical Analysis

As described above, system 100 does not rely on using a spectrometer to analyze reflected light 134R to ascertain a value for the resonant wavelength λ_{R}. Rather, the two-photodetector system 100 detects the intensity of the reflected light 134R as passed through optical edge filter 112 and converts the detected intensity, as represented by signals S₁ and S₂ from photodetectors 114-1 and 114-2, into a resonant wavelength λ_{R}. The following mathematical analysis describes how signals S₁ and S₂ are processed to calculate the normalized (or self-normalized) system signal S_{N} (or S_{SN}) representative of resonant wavelength λ_{R}.

It is assumed that both the broadband optical source power spectral density P_{BBS} of light source unit 106 and the responsivity [symbol] of the one or more photodetectors 114 are constant over the spectral region of interest, i.e.,

P_{BBS}(λ)=PₒW/nm (1)

[symbol]

(λ)= [symbol] A/W (2)

It is also assumed that the entire system 100 is uniform in the spatial Cartesian coordinate system (x, y, z). Optical edge filter 112 is characterized by a linear change in transmittance over the spectral region of interest, i.e.

$${T}_{F} ( λ ) = \{ \begin{matrix}0 & λ \leq {λ}_{e} \\ {S}_{F} ( λ - {λ}_{e} ) & {λ}_{e} < λ \leq {λ}_{e} + {S}_{F}^{- 1} \\ 1 & λ > {λ}_{e} + {S}_{F}^{- 1}\end{matrix} \qquad ( 3 )$$

where S_{F} is the slope of the filter edge in units of nm⁻¹ and λₑ is the spectral position of the filter edge. The edge filter shape for S_{F}= 1/10 nm⁻¹ and λₑ=825 nm is shown in FIG. 2.

The reflectance spectrum of RWG biosensor 102 can be characterized by the general function

R(λ,λ_{R})=Rₒ(λ−λ_{R}) (4)

where λ_{R} is the resonance wavelength, i.e., the spectral location of the resonance peak and shifts with refractive index changes at the sensor surface. For mathematical simplicity it is assumed that R(λ,λ_{R}) is normalized to unity, i.e.

$${\int }_{- ∞}^{+ ∞} R ( λ , {λ}_{R} ) d λ = 1 \qquad ( 5 )$$

and has units of wavelength (nm). Finally, each photodetector 114 integrates over all incident optical wavelengths to yield the system response when the reflected resonance is located at λ_{R}:

$${I}_{1} ( {λ}_{R} ) = {\int }_{- ∞}^{+ ∞} {P}_{BBS} ( λ ) R ( λ , {λ}_{R} ) {T}_{F} ( λ ) ( λ ) d λ \qquad ( 6 )$$

Using the above definitions and substituting in the edge filter functional response results in the following expression for the system photocurrent:

$${I}_{1} ( {λ}_{R} ) = \{ \begin{matrix}0 & {λ}_{R} \leq {λ}_{e} \\ {P}_{o} {S}_{F} {\int }_{{λ}_{e}}^{{λ}_{e} + {S}_{F}^{- 1}} ( λ - {λ}_{e} ) {R}_{o} ( λ - {λ}_{R} ) d λ & {λ}_{e} < {λ}_{R} \leq {λ}_{e} + {S}_{F}^{- 1} \\ {P}_{o} & {λ}_{R} \geq {λ}_{e} + {S}_{F}^{- 1}\end{matrix} \qquad ( 7 )$$

This expression is only valid when the resonant wavelength λ_{R} is sufficiently far away from the transition regions of the edge filter function relative to the spectral width of the R(λ,λ_{R}). The spectral regions where the photocurrent is constant do not contain any useful information and can be ignored. As a result, the above expression for the photocurrent simplifies to

$${I}_{1} ( {λ}_{R} ) = {P}_{o} {S}_{F} [ {\int }_{{λ}_{e}}^{{λ}_{e} + {S}_{F}^{- 1}} λ {R}_{o} ( λ - {λ}_{R} ) d λ - {λ}_{e} ] \qquad ( 8 )$$

The photocurrent is proportional to the expectation value, or center of mass, centroid, etc., of the biosensor reflectance spectrum. The expectation value of R(λ,λ_{R}) is given by the expression

$$〈 R ( λ , {λ}_{R} ) 〉 = {\int }_{- ∞}^{+ ∞} λ {R}_{o} ( λ - {λ}_{R} ) d λ \qquad ( 9 )$$

This is precisely what is measured in optical reader systems that use traditional spectroscopic means to measure the resonance wavelength. However, system 100 of the present disclosure generates the same information without ever having to directly spectrally measure and resolve the biosensor reflectance spectrum via spectroscopic means. Further, it avoids the need to implement complex centroid algorithms to determine the resonance wavelength.

Certain conditions are required to ensure that system 100 only measures changes in the resonant wavelength. First, the power Pₒ from light source unit 106 and the detector responsivity [symbol] must be stable. Typically, at constant temperature the photodiode responsivity is stable. However, the power produced by light source unit 106 may drift with time. As a result, the optical power of light source unit 106 is preferably monitored and used to normalize the measured signal S₁.

Systems 100 of FIG. 5B and FIG. 5D include a power monitoring system in the form of a beamsplitter 140 of known reflectivity/transmittance arranged in the optical path OP in incident light 134I, and a monitoring photodetector 142 arranged to receive a known portion or fraction (α) of incident light 134I redirected to the photodetector in the form of measurement light 134IM. Monitoring photodetector 142 sends a monitoring signal S_{M} to controller/signal processor 120 to provide a measure of the power in incident light 134I.

Hence, the power-normalized system signal S_{N} is defined by dividing by αPₒ [symbol] Δ_{BBS}, where it is assumed that the responsivity of monitoring photodetector 142 is the same as the measuring photodetector 114, α is the fraction of the source power split off for monitoring purposes by beamsplitter 140, and Δ_{BBS} is the spectral width of the optical source:

$${S}_{N} ( {λ}_{R} ) = [ \frac{( 1 - α )}{{αΔ}_{BBS}} ] {S}_{F} [ {\int }_{{λ}_{e}}^{{λ}_{e} + {S}_{F}^{- 1}} λ {R}_{o} ( λ - {λ}_{R} ) d λ - {λ}_{e} ] \qquad ( 10 )$$

This method negates the detrimental effects of power drift in light source unit 106. However, even with this improvement in the overall stability of system 100, the system is still sensitive to perturbations that change the optical power detected by photodetector unit 110. For example, if during operation a defect appears (a smudge, water droplet, fingerprint, a piece of debris, etc.) on the RWG biosensor 102 between readings, the defect will reduce the received optical power and decrease the signal S_{N}(λ_{R}), and hence, be interpreted as an erroneous wavelength change. This is illustrated mathematically by including a scale factor γ. The photodetector 114 not only performs a spectral integration as shown in Eq. 6, it also performs a spatial integration. As a result, γ is expressed as:

$$γ = ( \frac{1}{{A}_{PD}} ) \int {\int }_{{Detector}_{Dimension}} {T}_{D} ( x , y ) d x d y \qquad ( 11 )$$

where T_{D}(x,y) is the spatial “transmission” function of the defect and A_{PD} is the area of photodetector 114. With the assumption that a defect impacts all wavelengths equally, the expression for S_{N}(λ_{R}) now becomes:

$${S}_{N} ( {λ}_{R} , γ ) = [ \frac{γ ( 1 - α )}{{αΔ}_{BBS}} ] {S}_{F} [ {\int }_{{λ}_{e}}^{{λ}_{e} + {S}_{F}^{- 1}} λ {R}_{o} ( λ - {λ}_{R} ) d λ - {λ}_{e} ] \qquad ( 12 )$$

Finally, the impact of the “spectral shape” of both real light source units 106 and real photodetectors 114 are considered. To examine the impact of spectral non-uniformity, Eq. 12 is written to include the wavelength dependent terms in Eq. 6:

$$\begin{matrix}{S}_{N}^{Real} ( {λ}_{R} , γ ) = [ \frac{γ ( 1 - α )}{α {I}_{BBS}^{Tot}} ] {S}_{F} [ \begin{matrix}{\int }_{{λ}_{e}}^{{λ}_{e} + {S}_{F}^{- 1}} λ {P}_{BBS} ( λ ) ( λ ) {R}_{o} ( λ - {λ}_{R} ) d λ - \\ {λ}_{e} {\int }_{{λ}_{e}}^{{λ}_{e} + {S}_{F}^{- 1}} {P}_{BBS} ( λ ) ( λ ) {R}_{o} ( λ - {λ}_{R} ) d λ\end{matrix} ] \\ where & ( 13 ) \\ {I}_{BBS}^{Tot} = {\int }_{{All}_{Wavelengths} \\}^{ } ( λ ) {P}_{BBS} ( λ ) d λ & ( 14 )\end{matrix}$$

If the width of the R(λ,λ_{R}) is small compared to the spectral variation of the components in the system then R(λ,λ_{R}) can be approximately by the dirac delta function:

R(λ,λ_{R})≈δ(λ−λ_{R}) (15)

With this approximation Eq. 13 reduces to

$${S}_{N}^{Real} ( {λ}_{R} , γ ) = [ \frac{γ ( 1 - α )}{α {I}_{BBS}^{Tot}} ] {S}_{F} {P}_{BBS} ( {λ}_{R} ) ( {λ}_{R} ) ( {λ}_{R} - {λ}_{e} ) \qquad ( 16 )$$

The expression for the “real” signal generated by system 100 is complex and requires the careful control of the system components.

Example systems 100 as discussed above include the use of two photodetectors 114 in photodetector unit 110. The two-photodetector embodiments of system 100 generate detector signals S₁ and S₂ that can be used to form a self-normalized signal S_{SN} that is proportional to the wavelength shift of the RWG biosensor.

In most cases, optical filters generate both a transmitted signal and reflected signal and are optically lossless such that

T_{F}(λ)+R_{F}(λ1)=1 (17)

The reflectance of the optical edge filter 112 can be represented by R_{F}(λ)=1−T_{F}(λ):

$${R}_{F} ( λ ) = \{ \begin{matrix}1 & λ \leq {λ}_{e} \\ 1 - {S}_{F} ( λ - {λ}_{e} ) & {λ}_{e} < λ \leq {λ}_{e} + {S}_{F}^{- 1} \\ 0 & λ > {λ}_{e} + {S}_{F}^{- 1}\end{matrix} \qquad ( 18 )$$

The photocurrent generated by photodetector 114-2 is given by the expression

$${I}_{2} ( {λ}_{R} ) = {P}_{o} {\int }_{- ∞}^{+ ∞} {R}_{F} ( λ ) {R}_{o} ( λ - {λ}_{R} ) d λ \qquad ( 19 )$$

where it is assumed that both photodetectors 114-1 and 114-2 have the same responsivity. Again, ignoring the photocurrent generated in the “constant” spectral regions results in the following simplified expression for I₂

$${I}_{2} ( {λ}_{R} ) = {P}_{o} - {P}_{o} {S}_{F} [ {\int }_{{λ}_{e}}^{{λ}_{e} + {S}_{F}^{- 1}} λ {R}_{o} ( λ - {λ}_{R} ) d λ - {λ}_{e} ] \qquad ( 20 )$$

The photocurrent generated by photodetector 114-1 is the same as the single-photodiode system 100 shown in FIG. 5A and given by Eq. 8. Both photocurrents I₁ and I₂ can be used to generate a self-normalized output signal S_{SN} for the system. Thus, the following output signal is defined:

$${S}_{SN} ( {λ}_{R} ) = \frac{{I}_{2} ( {λ}_{R} ) - {I}_{1} ( {λ}_{R} )}{{I}_{2} ( {λ}_{R} ) + {I}_{1} ( {λ}_{R} )} \qquad ( 21 )$$

Substituting the expressions for I₁ and I₂ into the expression for S_{SN} and simplifying yields the self-normalized signal produced by the system:

$${S}_{SN} ( {λ}_{R} ) = 1 - 2 {S}_{F} [ {\int }_{{λ}_{e}}^{{λ}_{e} + {S}_{F}^{- 1}} λ {R}_{o} ( λ - {λ}_{R} ) d λ - {λ}_{e} ] \qquad ( 22 )$$

There are two benefits from using the self-normalized signal S_{SN}. First, power fluctuations in light source unit 106 are normalized out of the final signal, and second, the response of system 100 is increased by a factor of two as compared to the response of the single detector case that generates signal S_{N}.

In the case of a non-ideal system the signals I₁(λ_{R}) and I₂(λ_{R}) can be rewritten as

$$\begin{matrix} {I}_{1} ( {λ}_{R} , γ ) = γ {S}_{F} {\int }_{{λ}_{e}}^{{λ}_{e} + {S}_{F}^{- 1}} ( λ - {λ}_{e} ) {P}_{BBS} ( λ ) ( λ ) {R}_{o} ( λ - {λ}_{R} ) d λ & ( 23 ) \\ {I}_{2} ( {λ}_{R} , γ ) = γ [ \begin{matrix}{\int }_{{λ}_{e}}^{{λ}_{e} + {S}_{F}^{- 1}} {P}_{BBS} ( λ ) ( λ ) {R}_{o} ( λ - {λ}_{R} ) d λ - \\ {S}_{F} {\int }_{{λ}_{e}}^{{λ}_{e} + {S}_{F}^{- 1}} ( λ - {λ}_{e} ) {P}_{BBS} ( λ ) ( λ ) {R}_{o} ( λ - {λ}_{R} ) d λ\end{matrix} ] & ( 24 )\end{matrix}$$

Invoking Eq. 15 again yields the simplified expression for the two signals

I₁(λ_{R},γ)=γS_{F}P_{BBS}(λ_{R}) [symbol] (λ_{R})(λ_{R}−λₑ) (25)

I₂(λ_{R},γ)=γP_{BBS}(λ_{R}) [symbol] (λ_{R})−γS_{F}P_{BBS}(λ_{R}) [symbol] (λ_{R})(λ_{R}−λₑ) (26)

Substituting these expressions into Eq. 21 and simplifying yields the “real” self-normalized signal:

S_{SN}^{Real}(λ_{R})=1−2S_{F}(λ_{R}−λₑ) (27)

which is equivalent to Eq. 22 in the delta function limit.

Equation 22 shows that when non-ideal aspects of system 100 are included, such as light source unit power fluctuations, optical fringes due to multi-path interference, defects present on the microplate, the spectral dependence of the photodetector, etc, the final self-normalized signal S_{SN} produced by the system is independent of these perturbations. The result is therefore a robust and accurate measurement of the resonance wavelength without having to spectrally decompose the reflected light 134R from RWG biosensor 102.

In practical situations, the detector signals S₁ and S₂ are converted to voltages V₁ and V₂, and in embodiments, processor 122 is configured to: a) determine the first and second voltages V₁ and V₂ from the respective first and second detector signals S₁ and S₂; b) determine a difference V₂−V₁ between the first and second voltages; c) determine a sum V₁+V₂ of the first and second voltages; and d) divide the voltage difference by the voltage sum, i.e. S_{SN}=(V₂−V₁)/(V₂+V₁).

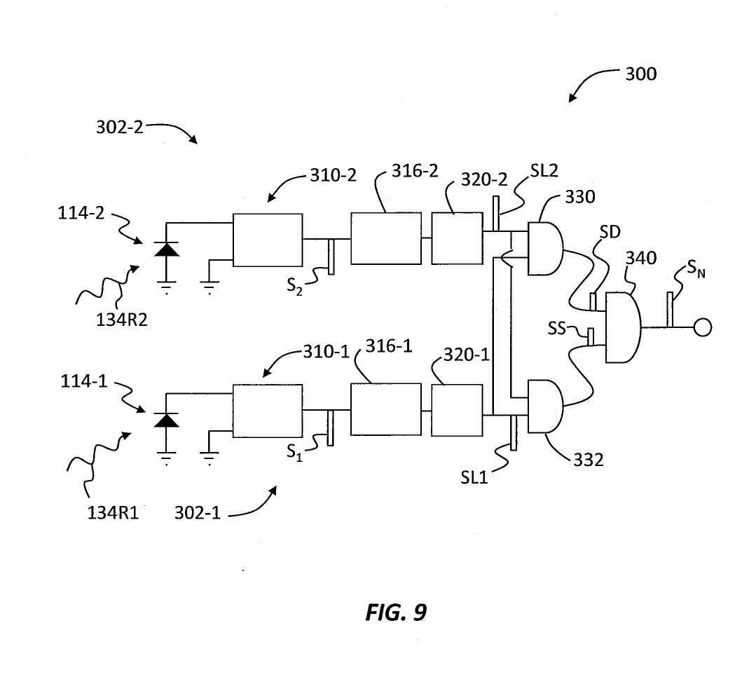

FIG. 9 is a schematic diagram of an example embodiment of a signal processing circuit 300 for processor 122 used to process detector signals S₁ and S₂ and the corresponding voltages V₁ and V₂. Signal processing circuitry 300 includes two branches 302-1 and 302-2 that each include in series a transimpedance amplifier (TIA) 310, an analog-to-digital converter (ADC) 316 and a low-pass filter (LPF) 320. Signals SL1 and SL2 are outputted by respective LPFs 320-1 and 320-2. The two circuit branches are connected at their respective LPF outputs to difference and sum logic circuitry 330 and 332, which are each connected to division logic circuitry 340.

LPF output signals SL1 and SL2 are inputted to difference and sum logic circuitry 330 and 332 to generate the difference and sum signals SD and SS, respectively. The difference and sum signals SD and SS are inputted into division logic circuitry 340 to form the self-normalized output signal S_{SN} of the system by dividing SD by SS.

It will be apparent to those skilled in the art that various modifications to the preferred embodiment of the disclosure as described herein can be made without departing from the scope of the disclosure as defined in the appended claims. Thus, the disclosure covers the modifications and variations provided they come within the scope of the appended claims and the equivalents thereto.

What is claimed is:

1. A non-spectroscopic optical reader system for reading a resonant waveguide grating (RWG) biosensor, comprising:
a broadband light source that generates broadband light that is incident on the RWG biosensor and that reflects therefrom to form biosensor-reflected light having an intensity;
a first photodetector arranged to receive the biosensor-reflected light and generate a first detector signal representative of the first intensity;
an optical edge filter to filter the broadband light, the biosensor-reflected light, or both; and
a signal processor to receive at least one first detector signal and to calculate therefrom a resonant wavelength for the RWG biosensor.

2. The system of claim 1, when the optical edge filter filters the biosensor-reflected light, then further comprising:
a second photodetector, with the first and second photodetectors disposed relative to the optical edge filter to respectively receive biosensor-reflected light transmitted through and reflected by the optical edge filter,
the second photodetector generates a second detector signal representative of a second intensity, and the signal processor calculates a resonant wavelength for the RWG biosensor based on the first and second detector signals.

3. The system of claim 2, further comprising:
a system axis that normally intersects the RWG biosensor;
a beamsplitter arranged along the system axis and configured so that the broadband light incident on the RWG biosensor and biosensor reflected light travel along a portion of the system axis; and
a polarizer and quarter-wave waveplate disposed along the system axis between the beamsplitter and the RWG biosensor to optically isolate the biosensor reflected light.

4. The system of claim 2, wherein the signal processor:
determines first and second voltages from the first and second detector signals;
determines a difference between the first and second voltages;
determines a sum of the first and second voltages; and
divides the voltage difference by the voltage sum.

5. The system of claim 1, further comprising an optical fiber section that optically connects either the broadband light source or the first photodetector to the optical edge filter.

6. The system of claim 2, further comprising first and second optical fiber sections that respectively optically connect the optical edge filter to the first and second photodetectors.

7. A non-spectroscopic optical system for label-independent reading of a resonant-waveguide (RWG) biosensor, comprising:
a broadband light source that generates broadband light that is incident on the RWG biosensor and reflects from the RWG biosensor;
an optical edge filter to transmit and reflect respective portions of light reflected from the RWG biosensor;
first and second photodetectors disposed relative to the optical edge filter to respectively receive the transmitted and reflected light portions and to generate respective first and second signals; and
a processor connected to the first and second photodetectors to receive the first and second signals and to generate a signal representative of a resonant wavelength of the RWG biosensor.

8. The system of claim 7, wherein the processor:
determines first and second voltages from the first and second signals;
determines a difference between the first and second voltages;
determines a sum of the first and second voltages; and
divides the voltage difference by the voltage sum.

9. The system of claim 7, further comprising an optical fiber section that optically connects the broadband light source or the first and second photodetectors to the optical edge filter.

10. The system of claim 7, further comprising an optical fiber section optically connected to the broadband light source.

11. The system of claim 10, further comprising at least one additional optical fiber section to guide reflected light from the optical edge filter to the first and second photodetectors.

12. A non-spectroscopic method of label-independent reading of a resonant-waveguide (RWG) biosensor operably supported by a support structure, comprising:
directing broadband light to a RWG biosensor to generate reflected light;
transmitting the incident broadband light or the reflected light through an optical edge filter;
detecting the transmitted and filtered portion of the reflected light with a first photodetector to generate a first signal representative of a first intensity of the reflected light; and
determining a resonant wavelength based on the first signal.

13. The method of claim 12, further comprising disposing the optical edge filter in the reflected light from the RWG biosensor.

14. The method of claim 12, further comprising directing the broadband light to the biosensor through at least one optical fiber section.

15. The method of claim 12, wherein directing the broadband light comprises scanning the broadband light over the RWG bionsensor.

16. The method of claim 12, further comprising providing the support structure as a microplate having a plurality of wells that each support a RWG biosensor to form an array of RWG biosensors.

17. The method of claim 12, further comprising:
reflecting at least a portion of the reflected light from the optical edge filter;
detecting the reflected portion with a second photodetector to generate a second signal representative of a second intensity; and
determining the resonant wavelength based on the first and second detector signals.

18. The method of claim 17, further comprising:
directing the incident broadband light and the reflected light along a portion of a system axis that is normal to the RWG biosensor; and
optically isolating the reflected light by passing the incident broadband light and the reflected light through a quarter-wave waveplate and a polarizer.

19. The method of claim 17, further comprising:
determining first and second voltages from the first and second signals;
determining a difference between the first and second voltages;
determining a sum of the first and second voltages; and
dividing the voltage difference by the voltage sum.

20. The method of claim 17, wherein the first and second photodetectors respectively comprise first and second image sensors, and respectively detecting the transmitted and reflected light portions with the first and second image sensors.

21. The method of claim 17, wherein the first and second photodetectors comprise at least one charge-coupled device (CCD).

22. The method of claim 17, wherein the first and second signals are representative of first and second voltages, and further comprising processing the first and second signals with a signal processor to calculate the resonant wavelength based on the first and second voltages.
